(19) United States
(12) Patent Application Publication
(10) Pub. No.: US 2021/0278682 A1
(43) Pub. Date: Sep. 9, 2021

(54) WAVE TRANSFORMATION METHOD

(71) Applicant: Soyuan Technology Co., Ltd., Tainan City (TW)

(72) Inventor: KUAN-REN CHEN, TAINAN CITY (TW)

(21) Appl. No.: 17/192,415

(22) Filed: Mar. 4, 2021

Related U.S. Application Data
(60) Provisional application No. 62/984,974, filed on Mar. 4, 2020.

(51) Int. Cl. G02B 27/10

(52) U.S. Cl. CPC G02B 27/1086

(57) ABSTRACT

A wave transformation method is disclosed. The method includes the following steps: disposing a transmitting space formed by a time dimension or a spatial dimension; generating a plurality of waves in the transmitting space and each of the plurality of waves has a first characteristic; arranging the plurality of waves in the transmitting space with the configuration and the configuration has a second characteristic; conducting a linear-beat process to form a resultant wave in the transmitting space and the resultant wave has a third characteristic combining the first characteristic and the second characteristic

### CROSS-REFFERENCE TO RELATED APPLICATION

This application claims priority from U.S. Patent Provisional Application No. 62/984,974, filed on Mar. 4, 2020, in the United States Patent and Trademark Office, the content of which is hereby incorporated by reference in its entirety for all purposes.

### BACKGROUND OF THE INVENTION

### 1. Field of the Invention

The present disclosure generally relates to a wave transformation method, and in particular, to the wave transformation method that forms a resultant wave by combining a first characteristic of the waves in the transmitting space and a second characteristic set by the configuration of the waves.

### 2. Description of the Related Art

The wave transmitting techniques are generally used in the current electromagnetic, optics, electronics, imaging, biomedical, precision measurement and other industries. To generate the different wave characteristics, the wave source or the signal generator must be set or adjusted to meet the requirements of various wavelengths, frequencies, or distribution in time or space. However, the devices are mostly made by the fixed specifications, and it is difficult to adjust accordingly. Taking the light source generated by the optic element for instance, the wavelength of the light is determined by the specifications of the component itself. If the different wavelengths are needed, the new optic element is required. The cost of the device is increased and it is quite restrictive in practice or in real operation.

In addition, when the generated wave still hard to meet the required characteristic by replacing the different wave sources, the specific adjustment device is needed to meet all requirements. The conventional adjustment method and the corresponding device are difficult to make the specific adjustment with the various wave sources. The adjustment methods still have some drawbacks.

Hence, the inventor provides the wave transformation method to improve the problems of conventional technology, so as to resolve the drawbacks and promote the industrial practicability.

### SUMMARY OF THE INVENTION

In view of the aforementioned technical problems, one objective of the present disclosure provides a wave transformation method, which is capable of solving the problem that the characteristics of existing waves are difficult to effectively adjust.

In accordance with one objective of the present disclosure, a wave transformation method is provided. The wave transformation method includes the following steps of: disposing a transmitting space, the transmitting space being formed by a time dimension or a spatial dimension; generating a plurality of waves in the transmitting space, each of the plurality of waves having a first characteristic; arranging the plurality of waves with a configuration having a second characteristic; and conducting a linear-beat process to form a resultant wave, the resultant wave having a third characteristic combining the first characteristic and the second characteristic.

Preferably, the configuration may include an input structure, a slit structure and an output structure. A start wave source is disposed at the input structure and the start wave source passes through the slit structure to form the plurality of waves at the output structure.

Preferably, the first characteristic may include a wavelength or a frequency of the plurality of waves and the second characteristic may include a time sequence or a spatial distribution of the plurality of waves.

Preferably, the plurality of waves may be generated by two reflections forming in one-dimensional space.

Preferably, the plurality of waves may be generated by three reflections forming in two-dimensional space.

Preferably, the first characteristic may include a wavelength or a frequency of the plurality of waves and the second characteristic may include a time sequence or a spatial distribution of the plurality of waves.

Preferably, the configuration may include a first input structure, a first slit structure, a first output structure, a second input structure, a second slit structure and a second output structure. A parallel wave source is disposed at the first input structure and the second input structure and the parallel wave source passes through the first slit structure and the second slit structure to form the plurality of waves at the first output structure and the second output structure.

Preferably, the first input structure and the second input structure may be separated by a preset distance.

Preferably, the first slit structure and the second slit structure may be arranged by a preset angle.

Preferably, the first output structure and the second output structure may be connected.

Preferably, the first characteristic may include a wavelength or a frequency of the plurality of waves and the second characteristic may include a time sequence or a spatial distribution of the plurality of waves.

Preferably, the configuration may include an input structure, a slit structure, a groove structure and an output structure. Wherein the output structure and an opening of the groove structure face the same direction. A parallel wave source is disposed at the input structure and the parallel wave source passes through the slit structure to form the plurality of waves with a point wave source of the groove structure.

Preferably, the groove structure and the output structure may be separated by a setting distance.

Preferably, the groove structure may be arranged on both sides of the output structure.

Preferably, the first characteristic may include a wavelength or a frequency of the plurality of waves and the second characteristic may include a time sequence or a spatial distribution of the plurality of waves.

Preferably, the configuration may include a plurality of point wave sources and the plurality of point wave sources generate the plurality of waves through time configuration or spatial configuration. Wherein the first characteristic includes a wavelength or a frequency of the plurality of waves and the second characteristic includes a time sequence or a spatial distribution of the plurality of waves.

Preferably, the plurality of point wave sources may be separated by a spacing distance.

As mentioned previously, the wave transformation method in accordance with the present disclosure may have one or more advantages as follows.

1. The wave transformation method is capable of conducting the linear-beat process through the configuration in the wave transmitting space. The starting wave source with the first characteristic can be adjusted by the second characteristic, so as to achieve the required third characteristic. The wave characteristics adjustment effect can be achieved effectively.

2. The wave transformation method may use the configuration in time dimension or spatial dimension. The plurality of waves are generated with specific characteristic. The configuration can be used as the operating parameters of the adjustment, so as to increase the diversity of adjustment methods and the scope of the application.

### BRIEF DESCRIPTION OF THE DRAWINGS

The technical features, detail structures, advantages and effects of the present disclosure will be described in more details hereinafter with reference to the accompanying drawings that show various embodiments of the invention as follows.

FIG. 1 is a flow chart of the wave transformation method in accordance with the embodiment of the present disclosure.

FIG. 2 is a schematic diagram of the configuration structure in accordance with the first embodiment of the present disclosure.

FIGS. 3A, 3B, and 3C are schematic diagrams of phase delay in accordance with the embodiment of the present disclosure.

FIGS. 4A and 4B are schematic diagrams of the dimension spaces in accordance with the embodiment of the present disclosure.

FIGS. 5A and 5B are schematic diagrams of the configuration structure in accordance with the second embodiment of the present disclosure.

FIG. 6 is a schematic diagram of the configuration structure in accordance with the third embodiment of the present disclosure.

FIG. 7 is a schematic diagram of the configuration structure in accordance with the fourth embodiment of the present disclosure.

FIG. 8 is a schematic diagram of the configuration structure in accordance with the fifth embodiment of the present disclosure.

### DETAILED DESCRIPTION OF THE PREFERRED EMBODIMENTS

In order to facilitate the understanding of the technical features, the contents and the advantages of the present disclosure, and the effectiveness thereof that can be achieved, the present disclosure will be illustrated in detail below through embodiments with reference to the accompanying drawings. On the other hand, the diagrams used herein are merely intended to be schematic and auxiliary to the specification, but are not necessary to be true scale and precise configuration after implementing the present disclosure. Thus, it should not be interpreted in accordance with the scale and the configuration of the accompanying drawings to limit the scope of the present disclosure on the practical implementation.

In the specification, the same reference numbers are used in the drawings and description to refer to the same or like parts. It is to be acknowledged that, although the terms ‘first’, ‘second’, ‘third’, and so on, may be used herein to describe various elements, components, areas, layers and/or parts, these terms are used only for the purpose of distinguishing one element, component, area, layer and/or part from another element, component, area, layer and/or part. Thus, the terms are used for descriptive purposes only, and cannot be understood as indicating or implying relative importance or its sequence relationship.

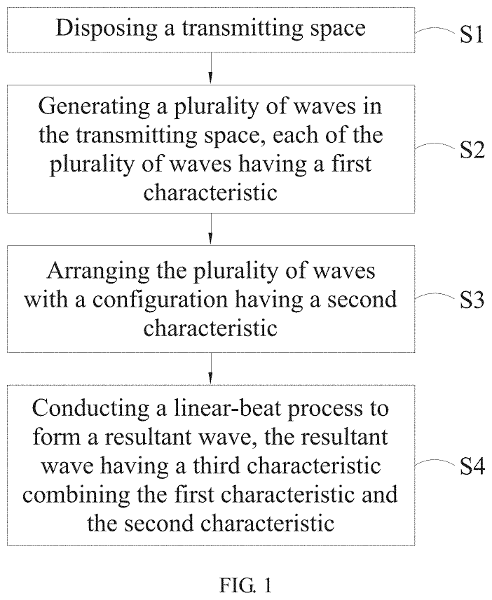

Please refer to FIG. 1, which is the flow chart of the wave transformation method in accordance with the embodiment of the present disclosure. As shown in the figure, the wave transformation method includes the following steps (S1-S4).

Step S1: disposing a transmitting space. The transmitting space is formed by a time dimension or a spatial dimension. Regarding the spatial dimension, the transmitting space can be set by disposing wave source, slit structure, reflection method or refraction method, so as to form a transmitting structure in actual coordinate space. The following steps may generate a plurality of waves based on such structure. In terms of the time dimension, the one or more wave sources may generate the plurality of waves through different wave generating sequences. In the present disclosure, the transmitting space can be made by the combination of the time dimension and the spatial dimension.

Step S2: generating a plurality of waves in the transmitting space, each of the plurality of waves having a first characteristic. Continue to the previous step, when the transmitting space is disposed, the one or more wave sources can be used to generate the plurality of waves. For example, the light waves generated by the light-emitting elements or the electromagnetic wave signal generated by the electromagnetic wave source signal generator. The different wave sources may have their corresponding characteristics. That is, the wave sources have the first characteristic such as wavelength or frequency of the waves. The first characteristic varies according to the type of wave source, and usually has a preset characteristic value.

Step S3: arranging the plurality of waves with a configuration having a second characteristic. Based on the arrangement in time dimension or in spatial dimension, the configuration structure may generate the plurality of waves in the transmitting space. When the wave source or the wave generated by the wave source pass through the configuration structure, the plurality of waves will be generated. The types of these waves are generated by the spatial structure or generated by the time sequence. For example, the position, width or quantity set for the slit, or the pulse waves generated by different time sequences. These waves will have different second characteristics according to the different configuration structures.

Step S4: conducting a linear-beat process to form a resultant wave, the resultant wave having a third characteristic combining the first characteristic and the second characteristic. Regarding the plurality of waves generated in spatial dimension or in time dimension, the waves may form the resultant wave in the transmitting space after passing the configuration. The resultant wave has the third characteristic, which is the combination of the first characteristic and the second characteristic. As mentioned above, most of the first characteristic has wave characteristic with preset characteristic value. However, the change from the configuration may incorporate the second characteristic into the first characteristic, so as to effectively adjust the characteristic of the resultant wave. That is, the third characteristic needed for the resultant wave.

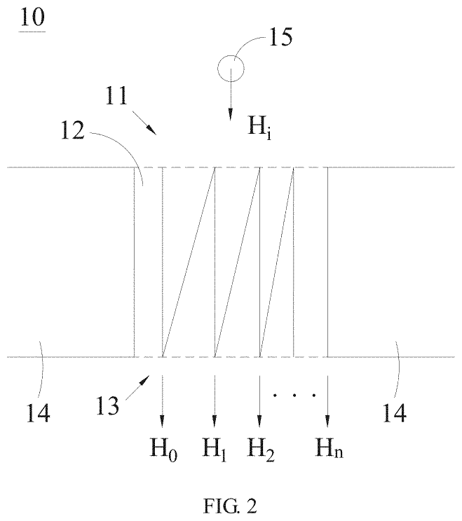

Please refer to FIG. 2, which is the schematic diagram of the configuration structure in accordance with the first embodiment of the present disclosure. As shown in the figure, the configuration structure 10 includes an input structure 11, a slit structure 12 and an output structure 13. The slit structure 12 is an opening or an aperture of the conductive layer. Apertures include hole and slit. For example, a through hole is disposed on a metal plate 14. The opening of the through hole along one surface of the metal plate 14 is set as the input structure 11. The output structure 13 is set along the other surface of the metal plate 14. In the present embodiment, the metal plate 14 can be a plate made by a single metal layer. However, the present disclosure is not limited on this embodiment. In other embodiment, the metal plate may include a metal film attached on the other material. The width of the opening can be less than a few wavelengths. Take the present embodiment for instance, the width of the opening may be 200nm. A start wave source Hi is disposed at the input structure 11. The start wave source Hi is the wave emitted towards the slit structure 12. The start wave source Hi may be the wave source with predetermined wavelength or frequency, such as electromagnetic wave or light wave. The start wave source Hi passes through the slit structure 13 and forms the plurality of waves H0, H1, . . . Hn at the output structure after conducting several transmission and reflection.

In the present embodiment, when the start wave source Hi passes through the slit structure 12, the different phases of the waves will be output at the output structure13. The plurality of waves H0, H1, . . . Hn can be represented by the following formula:

Hi(q)=Hi(q)e^{i[Pc×(q-q}^{ⁱ}^{)]} (1)

wherein q is the transmitting space, Pc is the first characteristic, which may be wavelength or frequency of the wave. Based on the different output sequence or the spatial arrangement, the plurality of waves may have the second characteristic at the output structure. These waves forms a resultant wave H in the transmitting space q through a linear-beat process, which can be represented by the following formula:

H=Σᵢ₌₀ⁿHi(q)=ΣHd(Pd)e^{i(Pc+Pd)×q} (2)

As shown from the above formula, the characteristic of the resultant wave H is the combination of the first characteristic Pc and the second characteristic Pd. That is, the final output at the output structure 13 is the result combining the first characteristic Pc and the second characteristic Pd. The start wave source Hi may have preset wavelength or frequency as the first characteristic Pc. Generally, these characteristics are difficult to adjust. For example, the first characteristic Pc generated by the light-emitting device or signal generating device are usually fixed. However, the slit structure 12 or the other spatial configuration can be made and the plurality of waves H0, H1, . . . Hn output from the output structurel3 may have the second characteristic Pd. The second characteristic Pd can be adjusted by changing the configuration structure. The resultant wave H can be easily adjusted to obtain the specific wave characteristic.

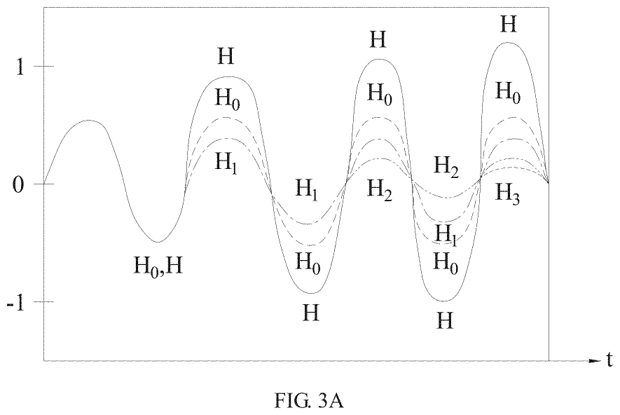

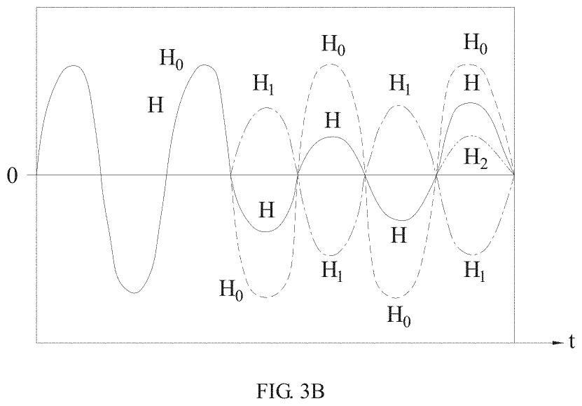

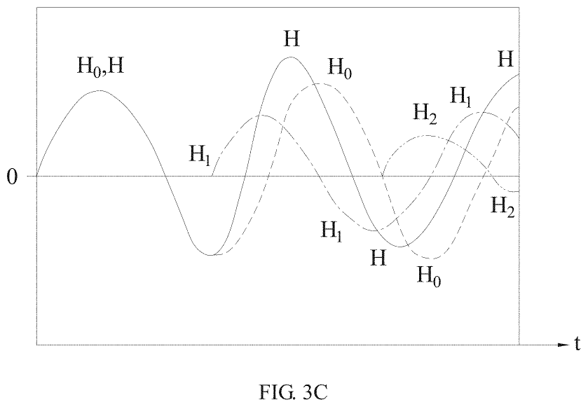

Please refer to FIGS. 3A, 3B and 3C, which are schematic diagrams of phase delay in accordance with the embodiment of the present disclosure. FIG. 3A is the schematic diagram when Ø=2π. FIG. 3B is the schematic diagram when Ø=3π. FIG. 3C is the schematic diagram when Ø=1.5π. As shown in the figures, when the start wave source Hi passes through the slit structure 12, the resultant wave H may have different output according to different time sequences. Take FIG. 3A for example, when the phase delay is Ø=2π, the waveform of the plurality of waves H0, H1, . . . Hn and the resultant wave H are shown in the figure. The waveforms of FIG. 3B and FIG. 3C show the situation of different phase delay. In the present disclosure, the value of the phase delay can be any value and can be adjusted by the demand for actual output resultant wave H.

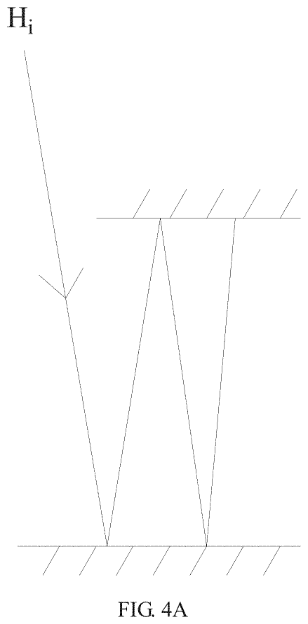

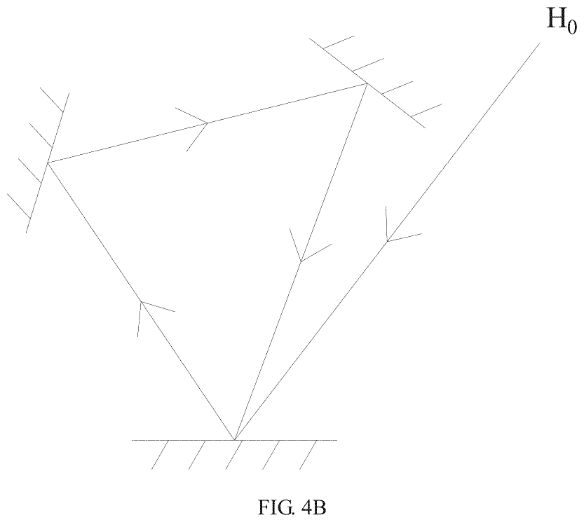

Please refer to FIGS. 4A and 4B, which are schematic diagrams of the dimension spaces in accordance with the embodiment of the present disclosure. FIG. 4A is the schematic diagram of the one-dimensional space and FIG. 4B is the schematic diagram of the two-dimensional space. As shown in the figure, the start wave source Hi can form two reflections by the structure in the one-dimensional space. The plurality of waves are generated through the reflection method in the one-dimensional space. In the two-dimensional space, the three reflections can be formed by the structure. The plurality of waves are generated through the reflection method in the two-dimensional space. The present disclosure is not limited on this, in other embodiments, the wave source may conduct more reflections in higher dimensional space to obtain the specific wave characteristic.

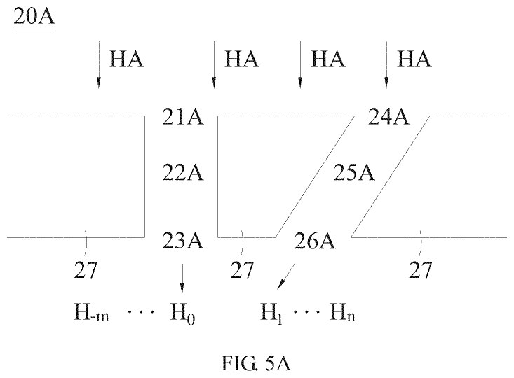

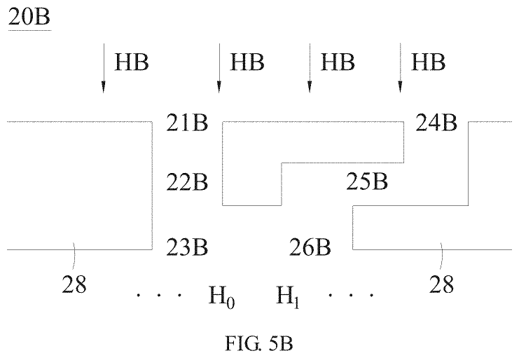

Please refer to FIGS. 5A and 5B, which are schematic diagrams of the configuration structure in accordance with the second embodiment of the present disclosure. FIG. 5A is the schematic diagram that the first output structure and the second output structure are separated and FIG. 5B is the schematic diagram that the first output structure and the second output structure are connected. As shown in FIG. 5A, the configuration structure 20A includes a first input structure 21A, a first slit structure 22A, a first output structure 23A, a second input structure 24A, a second slit structure 25A and a second output structure 26A. The configuration structure 20A can be disposed on the metal plate 27. The first input structure 21A, the first slit structure 22A and the first output structure 23A are the first hole. The second input structure 24A, the second slit structure 25A and the second output structure 26A are the second hole adjacent to the first hole. Regarding the setting position, the first input structure 21A and the second input structure 24A are separated by a preset distance. The preset distance is determined by the wavelength of the parallel wave source HA. In the present embodiment, the configuration structure 20A includes two slits. However, the present disclosure is not limited on this. In the other embodiment, the configuration structure 20A may have more than two slits or can be formed by slit array in the multi-dimensional space.

The first slit structure 22A is perpendicular to the metal plate 27. The second slit structure 25A has different setting angle corresponded to the first slit structure 22A. However, the present disclosure is not limited on this. In the other embodiment, the first slit structure 22A is parallel to the second slit structure 25A. When the parallel wave source HA passes through the first slit structure 22A and the second slit structure 25A, the (m+n+1) waves H-m, . . . , H-1, H0, H1, . . . , Hn are generated at the first output structure 23A and the second output structure 26A. Similar to the previous embodiment, these waves may have second characteristic with different time sequence or spatial configuration according to the configuration of the holes. The second characteristic may combine the first characteristic of the original parallel wave source HA, so as to obtain the specific wave characteristic.

As shown in FIG. 5B, the configuration structure 20B includes a first input structure 21B, a first slit structure 22B, a first output structure 23B, a second input structure 24B, a second slit structure 25B and a second output structure 26B. The configuration structure 20B can be disposed on the metal plate 28. The first input structure 21B, the first slit structure 22B and the first output structure 23B are the first hole. The second input structure 24B, the second slit structure 25B and the second output structure 26B are the second hole adjacent to the first hole. The difference from the previous embodiment is that the first output structure 23B and the second output structure 26A are connected. The two output structures are combined as one output port and the waves are output through the output port.

When the parallel wave source HB passes through the first slit structure 22B and the second slit structure 25B, the (m+n+1) waves H-m, . . . , H-1, H0, H1, . . . , Hn are generated at the first output structure 23B and the second output structure 26B. Similar to the previous embodiment, these waves may have second characteristic with different time sequence or spatial configuration according to the configuration of the holes. The second characteristic may combine the first characteristic of the original parallel wave source HB, so as to obtain the specific wave characteristic.

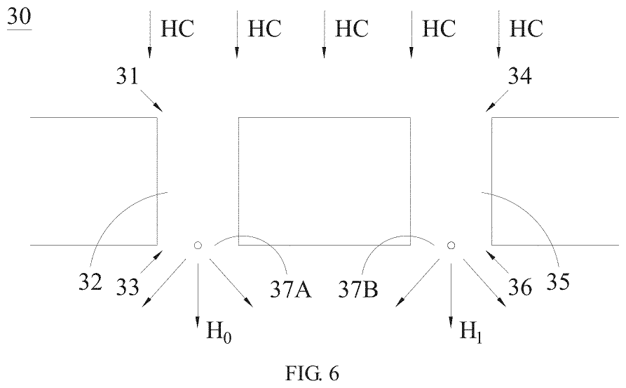

Please refer to FIG. 6, which is the schematic diagram of the configuration structure in accordance with the third embodiment of the present disclosure. As shown in the figure, the configuration structure 30 includes a first input structure 31, a first slit structure 32, a first output structure 33, a second input structure 34, a second slit structure 35 and a second output structure 36. The parallel wave source HC enters the first slit structure 32 and the second slit structure 35 from the first input structure 31 and the second input structure 34. The waves are output through the first output structure 33 and the second output structure 36. The difference from the previous embodiment is that the first point wave source 37A and the second point wave source 37B are further disposed at the first output structure 33 and the second output structure 36.

In the present embodiment, the parallel wave source HC is the parallel light source generated by optic structure, and the point wave source may be a point light source generated by a single light-emitting unit. When the parallel wave source HC passes through the slit structure, the plurality of waves H0, H1, . . . , Hn of the first point wave source 37A and the second point wave source 37B are formed. The waves are combined to generate the resultant wave with the required characteristic. In the previous embodiments, the second characteristic of the waves can be adjusted by the position, angle or quantity of the slits. In the present embodiment, the second characteristic can be further adjusted through the configuration of the point wave source. The adjustment to the resultant wave can be obtained more effectively.

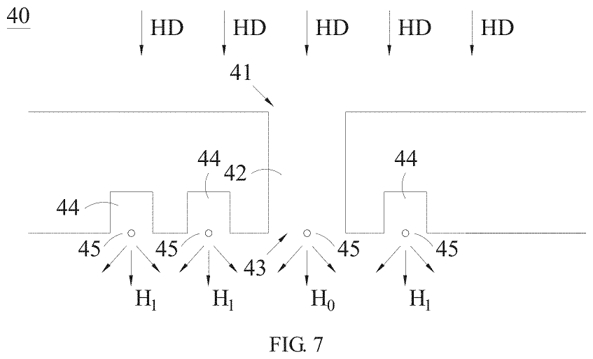

Please refer to FIG. 7, which is the schematic diagram of the configuration structure in accordance with the fourth embodiment of the present disclosure. As shown in the figure, the configuration structure 40 includes an input structure 41, a slit structure 42, an output structure 43 and a groove structure 44. The slit structure 42 is the through hole of the conductive layer. The opening of the through hole along one surface of the conductive layer is set as the input structure 41. The output structure 43 is set along the other surface of the conductive layer. The groove structure 44 is disposed on the same surface disposing the output structure 43. The openings of the groove structure 44 and the output structure 43 face toward the same direction. The groove structure 44 is disposed on both sides of the output structure 43. However, the present disclosure is not limited on this, the groove structure 44 may be disposed on one side of the output structure 43. The quantity and position of the groove structure 44 can be changed according to the number of slits and the demand of the second characteristic.

In the present embodiment, the point wave sources 45 are disposed at the output structure 43 and the groove structure 44. The difference from the previous embodiment is that the plurality of waves H0 at the output structure 43 are generated by the point wave sources 45 and the parallel wave source HD. The plurality of waves H1 at the groove structure 44 are generated by the point wave sources 45. When the surface current excited by the light passes through the surface of the groove, the charge is accelerated due to the change of direction, which generates a similar point wave source radiating outward. The waves also have the second characteristic according to the structure of slits and grooves. The second characteristic can be combined to the first characteristic of the point wave sources 45 and the parallel wave source HD, so as to obtain the required characteristics of the resultant wave.

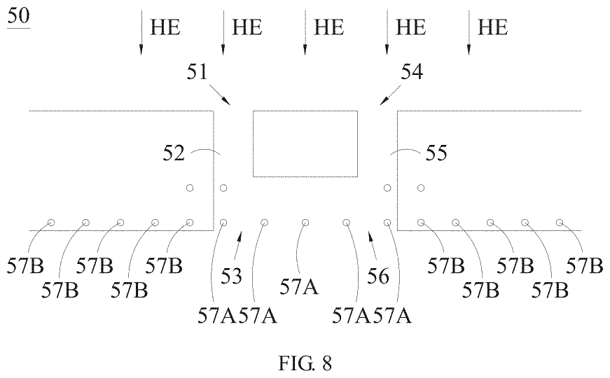

Please refer to FIG. 8, which is the schematic diagram of the configuration structure in accordance with the fifth embodiment of the present disclosure. As shown in the figure, the configuration structure 50 includes a first input structure 51, a first slit structure 52, a first output structure 53, a second input structure 54, a second slit structure 55 and a second output structure 56. The parallel wave source HE enters the first slit structure 52 and the second slit structure 55 from the first input structure 51 and the second input structure 54. The waves are output through the first output structure 53 and the second output structure 56. In the present embodiment, the first output structure 53 is connected to the second output structure 56, so as to form a single output port. The first point wave sources 57A are disposed at the output port. These first point wave sources 57A can be evenly arranged at the output port. In addition, the second point wave sources 57B are evenly arranged at the surface around the output port. The second point wave sources 57B are the mirror point wave source of the first point wave source 57A. The mirror point wave source is generated by compensating the multiple waves generated under the boundary conditions of the slit structure.

The same spacing distance is set between the first point wave sources 57A and the second point wave sources 57B. However, the present disclosure is not limited on this, the first spacing distance between the first point wave sources 57A and the second spacing distance between the second point wave sources 57B may be different. The structure of disposing the first point wave sources 57A and the second point wave sources 57B enables the multiple wave sources located at the output position. The multiple wave sources can be controlled independently. When the wave sources are opened at different staring sequences, the second characteristic may include the timing characteristic in the time dimension. The transformation method of the resultant wave can be further adjusted.

The present disclosure disclosed herein has been described by means of specific embodiments. However, numerous modifications, variations and enhancements can be made thereto without departing from the spirit and scope of the disclosure set forth in the claims.

What is claimed is:

1. A wave transformation method, the method comprising the following steps:
disposing a transmitting space, the transmitting space being formed by a time dimension or a spatial dimension;
generating a plurality of waves in the transmitting space, each of the plurality of waves having a first characteristic;
arranging the plurality of waves with a configuration having a second characteristic; and
conducting a linear-beat process to form a resultant wave, the resultant wave having a third characteristic combining the first characteristic and the second characteristic.

2. The wave transformation method of claim 1, wherein the configuration comprises an input structure, a slit structure and an output structure, a start wave source being disposed at the input structure and the start wave source passing through the slit structure to form the plurality of waves at the output structure.

3. The wave transformation method of claim 2, wherein the first characteristic comprises a wavelength or a frequency of the plurality of waves and the second characteristic comprises a time sequence or a spatial distribution of the plurality of waves.

4. The wave transformation method of claim 1, wherein the plurality of waves are generated by two reflections forming in one-dimensional space.

5. The wave transformation method of claim 1, wherein the plurality of waves are generated by three reflections forming in two-dimensional space.

6. The wave transformation method of claim 5, wherein the first characteristic comprises a wavelength or a frequency of the plurality of waves and the second characteristic comprises a time sequence or a spatial distribution of the plurality of waves.

7. The wave transformation method of claim 1, wherein the configuration comprises a first input structure, a first slit structure, a first output structure, a second input structure, a second slit structure and a second output structure, a parallel wave source being disposed at the first input structure and the second input structure and the parallel wave source passing through the first slit structure and the second slit structure to form the plurality of waves at the first output structure and the second output structure.

8. The wave transformation method of claim 7, wherein the first input structure and the second input structure are separated by a preset distance.

9. The wave transformation method of claim 7, wherein the first slit structure and the second slit structure are arranged by a preset angle.

10. The wave transformation method of claim 7, wherein the first output structure and the second output structure are connected.

11. The wave transformation method of claim 7, wherein the first characteristic comprises a wavelength or a frequency of the plurality of waves and the second characteristic comprises a time sequence or a spatial distribution of the plurality of waves.

12. The wave transformation method of claim 1, wherein the configuration comprises an input structure, a slit structure, a groove structure and an output structure, wherein the output structure and an opening of the groove structure face the same direction, a parallel wave source being disposed at the input structure and the parallel wave source passing through the slit structure to form the plurality of waves with a point wave source of the groove structure.

13. The wave transformation method of claim 12, wherein the groove structure and the output structure are separated by a setting distance.

14. The wave transformation method of claim 12, wherein the groove structure is arranged on both sides of the output structure.

15. The wave transformation method of claim 12, wherein the first characteristic comprises a wavelength or a frequency of the plurality of waves and the second characteristic comprises a time sequence or a spatial distribution of the plurality of waves.

16. The wave transformation method of claim 1, wherein the configuration comprises a plurality of point wave sources and the plurality of point wave sources generate the plurality of waves through time configuration or spatial configuration, wherein the first characteristic comprises a wavelength or a frequency of the plurality of waves and the second characteristic comprises a time sequence or a spatial distribution of the plurality of waves.

17. The wave transformation method of claim 16, wherein the plurality of point wave sources are separated by a spacing distance.
